(19) United States
(12) Patent Application Publication
(10) Pub. No.: US 2025/0286960 A1
(43) Pub. Date: Sep. 11, 2025

(54) FACSIMILE APPARATUS

(71) Applicant: SHARP KABUSHIKI KAISHA, Sakai City (JP)

(72) Inventor: Hiroshi NASUNO, Sakai City (JP)

(21) Appl. No.: 19/051,338

(22) Filed: Feb. 12, 2025

(30) Foreign Application Priority Data
Mar. 5, 2024 (JP) 2024-033168

(51) Int. Cl. H04N 1/00

(52) U.S. Cl. CPC H04N 1/00082; H04N 1/0001; H04N 1/00037; H04N 1/00076; H04N 1/001; H04N 1/00302; H04N 2201/0036; H04N 2201/0049; H04N 2201/0093

(57) ABSTRACT

A facsimile apparatus having a fax communication function of transmitting and receiving facsimile image data via an exchange and a modem, and a telephone call function of switching to an external telephone. The facsimile apparatus includes: a first terminal to which a facsimile line cable should be connected; a second terminal to which the external telephone should be connected; a line voltage detection sensor which is connected to the first terminal and detects a line voltage of the exchange; a selector switch which makes a switch as to whether the second terminal should be further connected to the line voltage detection sensor; and a controller. The controller controls the selector switch and determines, based on a first line voltage detected by the line voltage detection sensor, and a second line voltage detected by the line voltage detection sensor, a connection state of the facsimile line cable.

### CROSS-REFERENCE TO RELATED APPLICATION

The present application claims priority from Japanese Application JP2024-033168, the content to which is hereby incorporated by reference in to this publication.

### BACKGROUND OF THE DISCLOSURE

### Field of the Disclosure

The present disclosure relates to a facsimile apparatus, and more specifically, to a facsimile apparatus to which an external telephone can be connected.

### Description of the Background Art

As a configuration of a facsimile apparatus provided in a multifunction peripheral (MFP), which is an example of a multifunction machine, generally, the configuration includes two terminals (modular jacks), which are a terminal for connecting a facsimile line cable and a terminal for connecting an outside line telephone set.

Since the roles of these two terminals are different, a user must connect the cable correctly. However, since the appearance of these two terminals are the same, the user may make a mistake in inserting the cable.

In relation to such a problem, conventionally, there has been known a technology of a communication apparatus whereby it is possible to prevent occurrence of an event such as a trouble or a failure due to erroneous connection of a modular cable. In this technology, a circuit for voltage detection is provided on the side of a connection terminal for an external telephone set to detect a voltage applied to a telephone interface, and when it is determined that the detected voltage is greater than or equal to a voltage defined in advance, the user is notified of the possibility of erroneous connection.

However, if a circuit for voltage detection is separately added to detect a connection state of a facsimile line cable, there arises a problem in which the time and effort and the cost are increased by the addition.

The present disclosure has been conceived in consideration of the above circumstances, and an object of the present disclosure is to provide a facsimile apparatus capable of detecting erroneous connection or nonconnection of a facsimile line cable without separately adding a circuit for voltage detection.

### SUMMARY OF THE DISCLOSURE

A facsimile apparatus according to one aspect of the present disclosure pertains to a facsimile apparatus having a fax communication function of transmitting and receiving, to and from an external facsimile apparatus, facsimile image data via an exchange and a modem, and a telephone call function of switching to an external telephone and enabling a call to be made. The facsimile apparatus is provided with: a first terminal to which a facsimile line cable is to be connected; a second terminal to which the external telephone is to be connected; a line voltage detection sensor which is connected to the first terminal and detects a line voltage of the exchange; a selector switch which makes a switch as to whether the second terminal is to be further connected to the line voltage detection sensor; and at least one controller which controls the modem, the line voltage detection sensor, and the selector switch, in which the at least one controller controls the selector switch and determines, on the basis of a first line voltage detected by the line voltage detection sensor when only the first terminal is connected to the line voltage detection sensor, and a second line voltage detected by the line voltage detection sensor when the first terminal and the second terminal are connected to the line voltage detection sensor, a connection state of the facsimile line cable.

According to the present disclosure, on the basis of the first line voltage detected by the line voltage detection sensor when only the first terminal to which the facsimile line cable should be connected is connected to the line voltage detection sensor, and the second line voltage detected by the line voltage detection sensor when the first terminal and the second terminal to which the external telephone should be connected are connected to the line voltage detection sensor, the connection state of the facsimile line cable is determined. By performing such determination, it is possible to realize a facsimile apparatus capable of detecting erroneous connection or nonconnection of a facsimile line cable without separately adding a circuit for voltage detection.

### BRIEF DESCRIPTION OF THE DRAWINGS

FIG. 1 is a block diagram illustrating a schematic configuration of a facsimile apparatus according to Embodiment 1 of the present disclosure.

FIG. 2 is an explanatory diagram of a case where a facsimile line cable is erroneously connected in the facsimile apparatus of FIG. 1.

FIG. 3 is a flowchart illustrating a method of detecting erroneous connection or nonconnection of a facsimile line cable in the facsimile apparatus of FIG. 1.

FIG. 4 is a table illustrating determination of a connection state of a facsimile line cable in a case where an initial state of a switching portion of the facsimile apparatus of FIG. 1 is OFF.

FIG. 5 is an explanatory diagram of a case where the switching portion is switched to ON when the facsimile line cable is correctly connected in the facsimile apparatus of FIG. 1.

FIG. 6 is an explanatory diagram of a case where the switching portion is switched to ON when the facsimile line cable is erroneously connected in the facsimile apparatus of FIG. 1.

FIG. 7 is a table illustrating determination of a connection state of a facsimile line cable in a case where an initial state of the switching portion of the facsimile apparatus of FIG. 1 is ON.

FIG. 8 is a flowchart illustrating a flow from determination of a timing to detect erroneous connection or nonconnection of a facsimile line cable to displaying of an error message in a facsimile apparatus according to Embodiment 2 of the present disclosure.

FIGS. 9A, 9B, and 9C are explanatory diagrams illustrating examples of a timing to detect erroneous connection or nonconnection of the facsimile line cable of the facsimile apparatus according to Embodiment 2 of the present disclosure. FIG. 9A illustrates a start-up time type timing, FIG. 9B illustrates a polling type timing, and FIG. 9C illustrates an event type timing.

FIG. 10 is an example of an error message displayed on a display portion when erroneous connection or nonconnection is detected for the facsimile line cable in the facsimile apparatus according to Embodiment 2 of the present disclosure.

### DESCRIPTION OF THE PREFERRED EMBODIMENTS

Further, preferred aspects of the present disclosure will be described.

In the facsimile apparatus according to the present disclosure, a hook detection sensor which is connected to the second terminal and detects, on the basis of a current which flows through a bidirectional photocoupler, whether an off-hook state is exhibited may be provided, in which when the connection state of the facsimile line cable is to be detected, if the second terminal is not connected to the line voltage detection sensor and the line voltage detection sensor does not detect a line voltage of the exchange, the at least one controller may control, when the off-hook state is detected by the hook detection sensor, the selector switch and connect the second terminal to the line voltage detection sensor, and when the line voltage detection sensor does not detect a line voltage of the exchange, the facsimile line cable is determined as being not connected, and when the line voltage detection sensor detects a line voltage of the exchange, the facsimile line cable is determined as being erroneously connected.

In this way, by using the hook detection sensor which detects whether an off-hook state is exhibited on the basis of a current which flows through the bidirectional photocoupler to determine whether the facsimile line cable is erroneously connected or is not connected, it is possible to realize a facsimile apparatus capable of detecting erroneous connection or nonconnection of a facsimile line cable without separately adding a circuit for voltage detection.

In the facsimile apparatus according to the present disclosure, when the connection state of the facsimile line cable is to be detected, if the second terminal is connected to the line voltage detection sensor and the line voltage detection sensor detects a line voltage of the exchange, the at least one controller may control the selector switch and disconnect the second terminal from the line voltage detection sensor, and when the line voltage detection sensor detects the line voltage of the exchange, the facsimile line cable is determined as being correctly connected, and when the line voltage detection sensor does not detect the line voltage of the exchange, the facsimile line cable is determined as being erroneously connected.

In this way, in a case where the second terminal is connected to the line voltage detection sensor and the line voltage detection sensor detects a line voltage of the exchange, by first controlling the selector switch and disconnecting the second terminal from the line voltage detection sensor and then causing the line voltage detection sensor to detect the line voltage of the exchange, it is possible to realize a facsimile apparatus capable of detecting erroneous connection or nonconnection of a facsimile line cable without separately adding a circuit for voltage detection.

In the facsimile apparatus according to the present disclosure, the at least one controller may detect the connection state of the facsimile line cable at a timing when a power source of the apparatus is turned on or off, a timing defined in advance, or a timing when a cable is connected to one of the first terminal and the second terminal.

In this way, it is possible to realize a facsimile apparatus capable of detecting erroneous connection or nonconnection of a facsimile line cable at a more appropriate timing than by a conventional way.

In the facsimile apparatus according to the present disclosure, a display which displays various kinds of information to a user may further be provided, in which the at least one controller may cause the display to display, when erroneous connection or nonconnection of the facsimile line cable is detected as a result of detection of the connection state of the facsimile line cable, an error message defined in advance.

In this way, it is possible to realize a facsimile apparatus capable of displaying an error message when erroneous connection or nonconnection of the facsimile line cable is detected.

The present disclosure will now be described in more detail with reference to the accompanying drawings. Note that the following are described as examples in all respects, and should not be construed as limiting the present disclosure.

### Embodiment 1

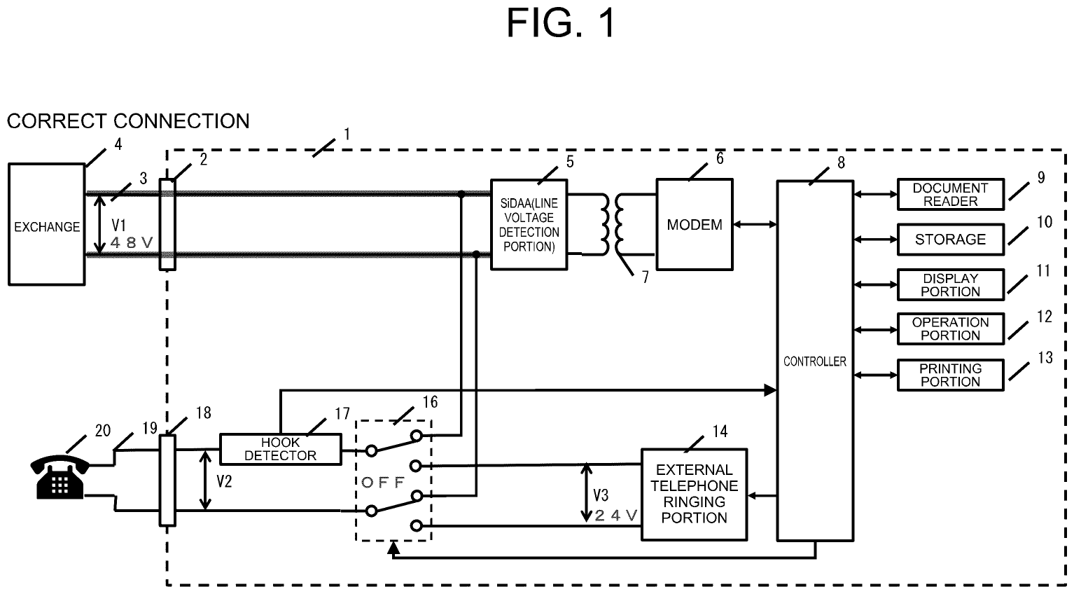

Configuration of Facsimile Apparatus 1 according to Embodiment 1 of Present Disclosure In the following, a schematic configuration of a facsimile apparatus 1 according Embodiment 1 of the present disclosure will be described with reference to FIG. 1.

FIG. 1 is a block diagram illustrating a schematic configuration of the facsimile apparatus 1 of the present disclosure.

In FIG. 1, publicly known configurations related to a facsimile communication function are omitted.

The facsimile apparatus 1 is an apparatus which electronically transmits and receives facsimile image data including information such as characters, images, and photographs, through a communication line.

The facsimile apparatus 1 also has the function of enabling a telephone conversation to be held with a person on the other end of the line by connecting an external telephone 20 (or a handset dedicated to fax communication) to the facsimile apparatus 1.

Each of the constituent elements of the facsimile apparatus 1 illustrated in FIG. 1 will be described below.

As illustrated in FIG. 1, the facsimile apparatus 1 is connected to an exchange 4 via a line cable 3, and connection to an SiDAA (Silicon Data Access Arrangement) (a line voltage detection portion 5) is established via a modular connector 2.

The line voltage detection portion 5 is a detection sensor connected to a modem 6 via a communication transformer 7, and the modem 6 is controlled by a controller 8.

The controller 8 is a processor which controls the facsimile apparatus 1 in an integrated manner, and is constituted of one or more central processing units (CPUs), one or more random-access memories (RAMs), one or more read-only memories (ROMs), various interface circuits, and the like.

The controller 8 transmits and receives, via the modem 6, facsimile image data to and from a facsimile apparatus on the other end of the line connected through the exchange 4.

The controller 8 controls a document reader 9 for reading a document image, and a storage 10 which stores therein a control program of the controller 8, and also information of a telephone book, various settings, and facsimile image data.

A display portion 11 is a display which displays various settings to a user.

An operation portion 12 is an operation device such as a touch panel or a keyboard/mouse which receives various operations from the user.

A printing portion 13 is a printer which prints a received fax communication image in accordance with an instruction from the controller 8.

Further, the facsimile apparatus 1 is connected to the external telephone 20 via a line cable 19, and one line of the line cable 19 is connected to a switching portion 16, which is a selector switch, via a modular connector 18 and a hook detector 17, and the other line of the line cable 19 is directly connected to the switching portion 16.

Incidentally, there is a case where the user picks up a telephone receiver of the external telephone 20 (i.e., takes the phone off the hook) before a fax transmission, and talks with a representative of a transmission destination to inform the representative of a fax number which is a connection destination.

In such a case, the switching portion 16 is controlled by the controller 8 so that the connection destination of the external telephone 20 is switched to the exchange 4 or an external telephone ringing portion 14.

In the example of FIG. 1, the switching portion 16 is set to OFF, and the connection destination of the external telephone 20 is connected to the exchange 4.

While a line voltage V1 applied from the exchange 4 is 48 volts, the polarity thereof is not fixed since the polarity depends on the environment, such as the type of the exchange 4 and the type of the cable.

In view of the above, the hook detector 17 is provided with a bidirectional photocoupler capable of responding to an inversion of the voltage polarity. When the external telephone 20 is off-hooked, the line is connected and a current also flows through the photocoupler, whereby a current detection signal is changed. Thus, it is possible to detect whether the external telephone 20 is in an off-hooked state.

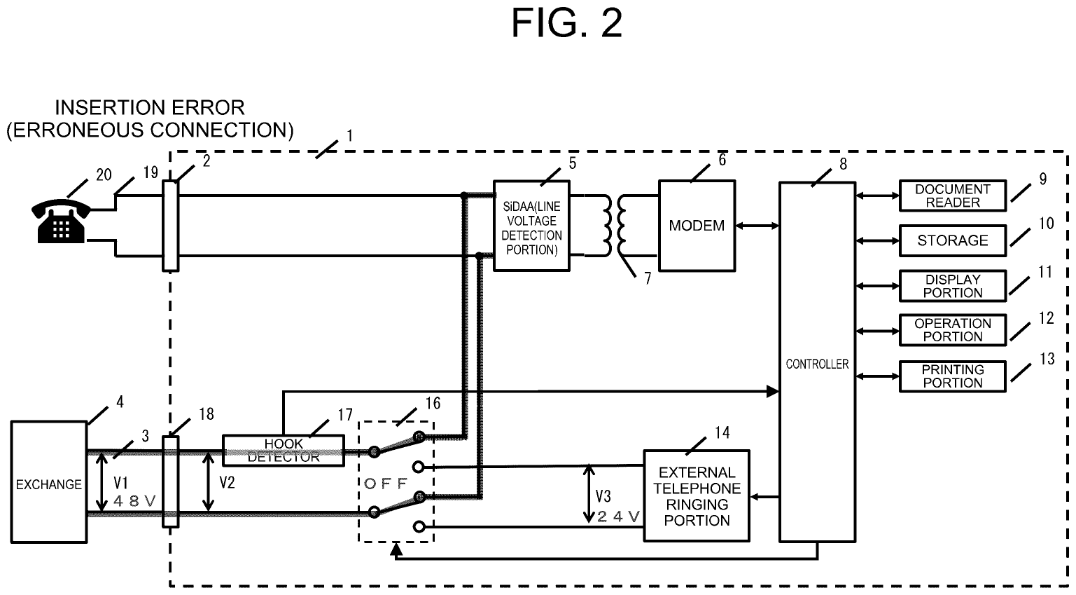

FIG. 2 is an explanatory diagram of a case where a facsimile line cable is erroneously connected in the facsimile apparatus 1 of FIG. 1.

In the present disclosure, as illustrated in FIG. 2, a case where a facsimile line cable (the line cable 3) is erroneously connected to a terminal (the modular connector 18) for connecting the external telephone 20 is assumed.

As a first reason of assuming the above case is that in the facsimile apparatus 1, it is essential that a facsimile line cable be connected in order to use the function related to a telephone line.

Further, as a second reason, some users may not use the external telephone 20.

Furthermore, as a third reason, there exists no method of use or function of connecting only the external telephone 20.

In light of the reasons given above, it is an object of the present disclosure to realize the facsimile apparatus 1 capable of detecting erroneous connection or nonconnection of a facsimile line cable.

### Method of Detecting Erroneous Connection or Nonconnection of Facsimile Line Cable in Facsimile Apparatus 1

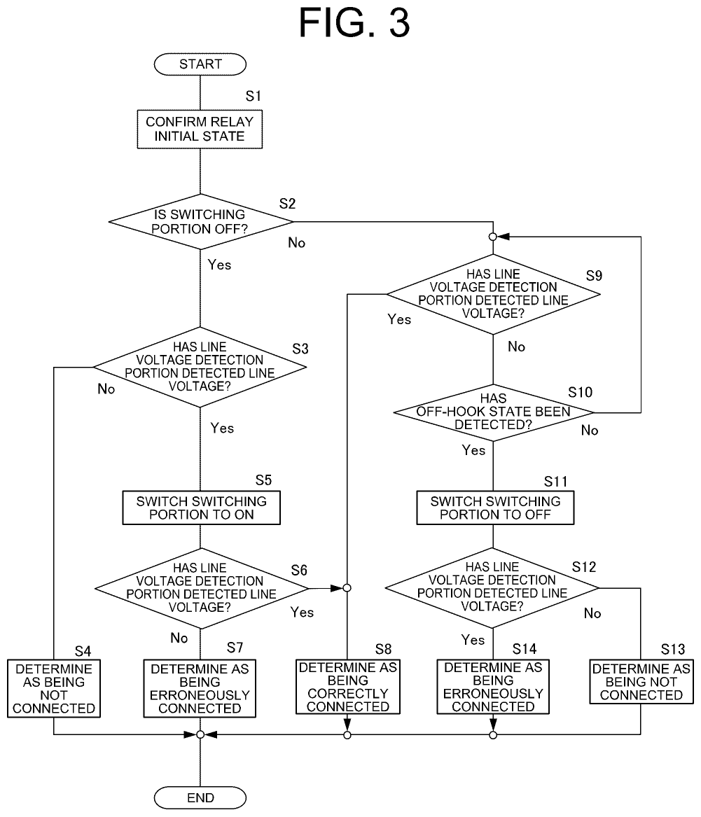

Next, with reference to FIG. 3, a method of detecting erroneous connection or nonconnection of a facsimile line cable in the facsimile apparatus 1 according to Embodiment 1 of the present disclosure will be described.

FIG. 3 is a flowchart illustrating a method of detecting erroneous connection or nonconnection of a facsimile line cable in the facsimile apparatus 1 of FIG. 1.

In step S1 of FIG. 3, the controller 8 of the facsimile apparatus 1 confirms the initial state of the switching portion 16 (step S1).

In step S2, if the switching portion 16 is set to OFF (i.e., if it is determined as being Yes in step S2), in step S3, it is determined whether or not the line voltage detection portion 5 has detected the line voltage V1 (step S3).

If the line voltage detection portion 5 does not detect the line voltage V1 (i.e., if it is determined as being No in step S3), in step S4, the controller 8 determines that the line is not connected (step S4).

By the determination as described above, it is possible to detect that the line is not connected in a case where the cable is not firmly connected or the cable has been disconnected for some reason, or a case where the cable has been broken.

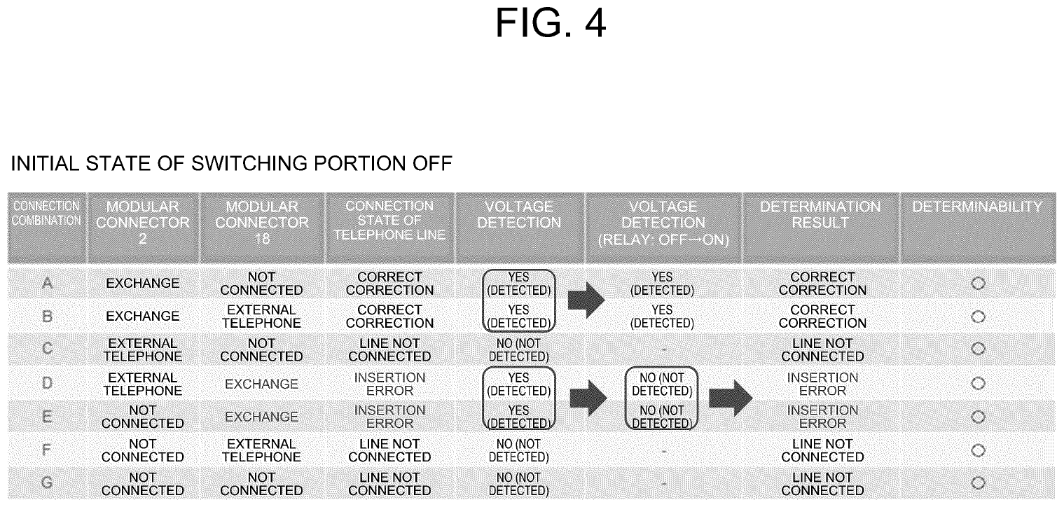

FIG. 4 is a table illustrating determination of a connection state of the facsimile line cable in a case where the initial state of the switching portion 16 of the facsimile apparatus 1 of FIG. 1 is OFF.

When the exchange 4 is not connected, the line voltage V1 is not detected.

The above case is a case where the exchange 4 is not connected to either the modular connector 2 or the modular connector 18, that is, a case where a connection combination corresponds to C, F, or G in the table of FIG. 4.

Here, when the exchange 4 is connected to either the modular connector 2 or the modular connector 18, the line voltage V1 is detected.

The above case is a case where the connection combination corresponds to A, B, D, or E in the table of FIG. 4.

Meanwhile, in step S3 of FIG. 3, if the line voltage detection portion 5 detects the line voltage V1 (i.e., if it is determined as being Yes in step S3), in step S5, the controller 8 switches the switching portion 16 to ON (step S5).

In the subsequent step S6, the controller 8 determines whether or not the line voltage detection portion 5 has detected the line voltage V1 (step S6).

If the line voltage detection portion 5 detects the line voltage V1 (i.e., if it is determined as being Yes in step S6), in step S8, the controller 8 determines that the line is correctly connected (step S8).

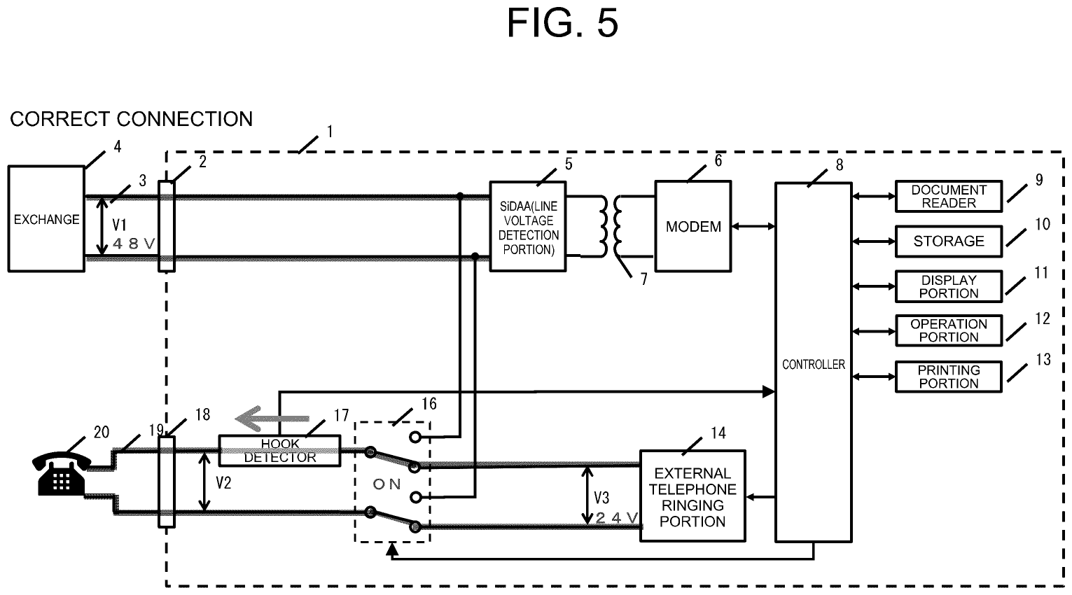

FIG. 5 is an explanatory diagram of a case where the state of the switching portion 16 is switched to ON when the facsimile line cable is correctly connected in the facsimile apparatus 1 of FIG. 1.

At this time, as indicated in FIG. 5, the line voltage detection portion 5 detects the line voltage V1.

The above case is a case where the connection combination corresponds to A or B in the table of FIG. 4.

Meanwhile, in step S6 of FIG. 3, if the line voltage detection portion 5 does not detect the line voltage V1 (i.e., if it is determined as being No in step S6), in step S7, the controller 8 determines that the line is erroneously connected (step S7).

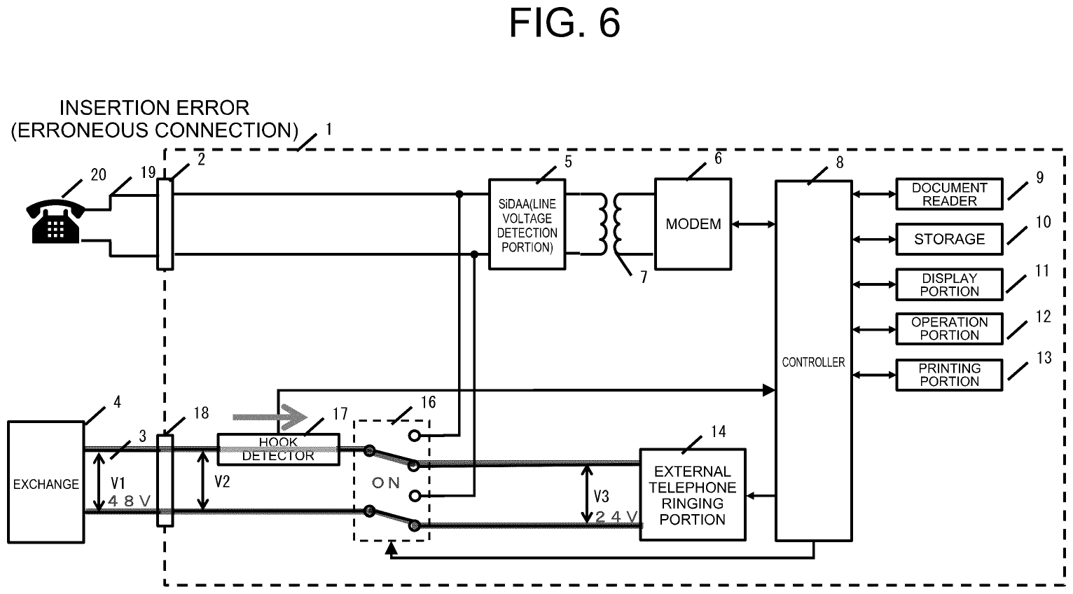

FIG. 6 is an explanatory diagram of a case where the state of the switching portion 16 is switched to ON when the facsimile line cable is erroneously connected in the facsimile apparatus 1 of FIG. 1.

At this time, as indicated in FIG. 6, the line voltage detection portion 5 does not detect the line voltage V1.

The above case is a case where the connection combination corresponds to D or E in the table of FIG. 4.

By performing the processing of steps S3 to S8 described above, a distinction can be made for the connection combination. That is, as illustrated in the table of FIG. 4, although the states in which the connection combinations are A, B, D, and E cannot be distinguished from each other by the detection of the line voltage V1 alone, by switching the switching portion 16 from OFF to ON and then detecting the line voltage V1, it becomes possible to distinguish the states in which the connection combinations are A and B from the states in which the connection combinations are D and E.

That is, by combining the detection of the line voltage V1 with the switching of the switching portion 16 as described above, it becomes possible to appropriately make a distinction of whether the facsimile line cable is correctly connected or erroneously connected.

Next, in step S2 of FIG. 3, if the switching portion 16 is set to ON (i.e., if it is determined as being No in step S2), in step S9, it is determined whether or not the line voltage detection portion 5 has detected the line voltage V1 (step S9).

If the line voltage detection portion 5 detects the line voltage V1 (i.e., if it is determined as being Yes in step S9), in step S8, the controller 8 determines that the line is correctly connected (step S8).

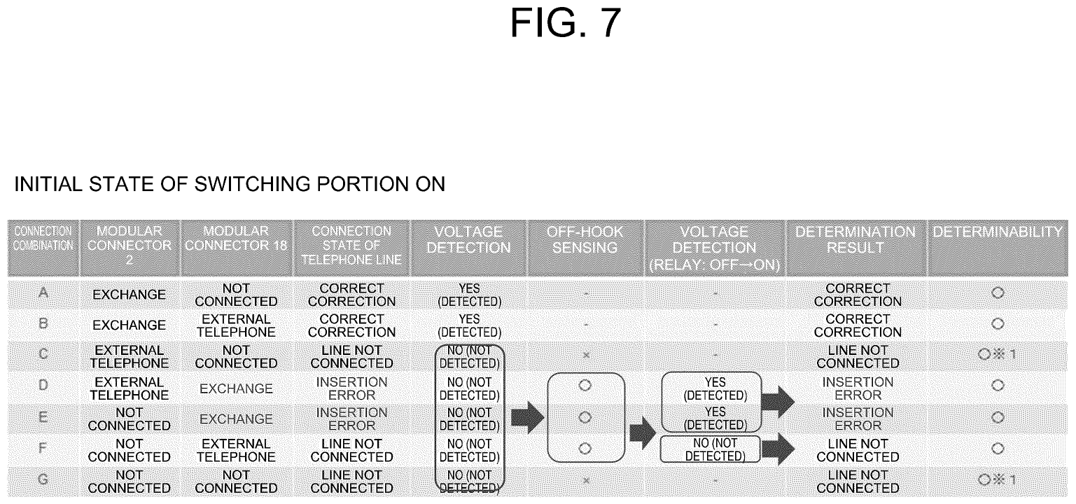

FIG. 7 is a table illustrating the determination of a connection state of the facsimile line cable in a case where the initial state of the switching portion 16 of the facsimile apparatus 1 of FIG. 1 is ON.

As indicated in FIG. 5, when the initial state of the switching portion 16 is ON in a case where the facsimile line cable is correctly connected, the line voltage detection portion 5 detects the line voltage V1.

That is, the above case is a case where the connection combination corresponds to A or B in the table of FIG. 7.

Meanwhile, in step S9, if the line voltage detection portion 5 does not detect the line voltage V1 (i.e., if it is determined as being No in step S9), in step S10, the controller 8 determines whether or not an off-hook state has been detected (step S10).

As indicated in FIG. 5, in a case where the line is correctly connected, when the switching portion 16 is set to ON, the external telephone 20 is connected to the external telephone ringing portion 14 and an output voltage V3 (+24 V) of the external telephone ringing portion 14 is applied as a terminal voltage V2 of the external telephone 20.

Here, when the user picks up the telephone receiver of the external telephone 20 and an off-hook state is exhibited, the hook detector 17 notifies the controller 8 of the off-hook state by changing a current detection signal.

Meanwhile, as illustrated in FIG. 6, in a case where the line is erroneously connected, when the switching portion 16 is set to ON, the exchange 4 is connected to the external telephone ringing portion 14.

At this time, since the output voltage V1 (+48 V) of the exchange 4 is greater than the output voltage V3 (+24 V) of the external telephone ringing portion 14, a current flows from the exchange 4 to the external telephone ringing portion 14, which means that a current also flows to the photocoupler of the hook detector 17 and a current detection signal is changed. Consequently, this case is also detected as an off-hook state.

In step S10 of FIG. 3, if the off-hook state is not detected (i.e., if it is determined as being No in step S10), the controller 8 returns the processing to the determination of step S9.

In this case, when a time defined in advance elapses, the display portion 11 may be made to display a predetermined message.

Meanwhile, if the off-hook state is detected (i.e., if it is determined as being Yes in step S10), in step S11, the controller 8 switches the switching portion 16 to OFF (step S11).

In the subsequent step S12, the controller 8 determines whether or not the line voltage detection portion 5 has detected the line voltage V1 (step S12).

If the line voltage detection portion 5 does not detect the line voltage V1 (i.e., if it is determined as being No in step S12), in step S13, the controller 8 determines that the line is not connected (step S13).

When the exchange 4 is not connected, the line voltage V1 is not detected even if the switching portion 16 is switched to OFF.

The above case is a case where the exchange 4 is not connected to either the modular connector 2 or the modular connector 18, that is, a case where a connection combination corresponds to F in the table of FIG. 7.

Meanwhile, if the line voltage detection portion 5 detects the line voltage V1 (i.e., if it is determined as being Yes in step S12), in step S14, the controller 8 determines that the line is erroneously connected (step S14).

When the line is erroneously connected, as indicated in FIG. 2, the line voltage detection portion 5 detects the line voltage V1 of the exchange 4.

The above case is a case where the connection combination corresponds to D or E in the table of FIG. 7.

By performing the processing of steps S9 to S14 described above, a distinction can be made for the connection combination. That is, as illustrated in the table of FIG. 7, although the states in which the connection combinations are C to G cannot be distinguished from each other by the detection of the line voltage V1 alone, by adding the detection of the off-hook state to the above detection, it becomes possible to distinguish the states in which the connection combinations are C and G from the states in which the connection combinations are D to F. Further, by switching the switching portion 16 from ON to OFF and then detecting the line voltage V1, it becomes possible to distinguish the states in which the connection combinations are D and E from the state in which the connection combination is F.

That is, by combining the detection of the line voltage V1 with the detection of the off-hook state and the switching of the switching portion 16 as described above, it becomes possible to appropriately make a distinction of whether the facsimile line cable is erroneously connected or is not connected.

As described above, on the basis of a (first) line voltage detected by the line voltage detection portion 5 when only the modular connector 2 to which the facsimile line cable should be connected is connected to the line voltage detection portion 5, and a (second) line voltage detected by the line voltage detection portion 5 when the modular connector 2 and the modular connector 18 to which the external telephone should be connected are connected to the line voltage detection portion 5, the connection state of the facsimile line cable is determined. By performing such determination, it is possible to realize the facsimile apparatus 1 capable of detecting erroneous connection or nonconnection of a facsimile line cable without separately adding a circuit for voltage detection.

### Embodiment 2

Flow from Determination of Timing to Detect Erroneous Connection or Nonconnection of Facsimile Line Cable to Displaying of Error Message in Facsimile Apparatus 1 According to Embodiment 2 of Present Disclosure

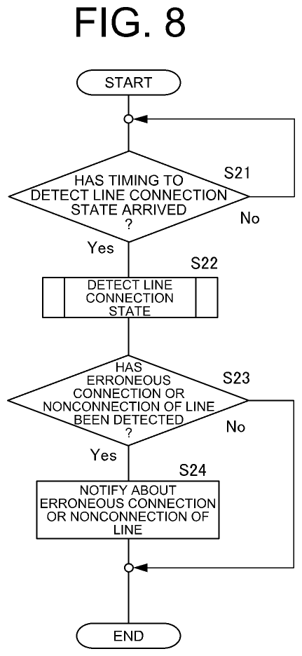

Next, with reference to FIGS. 8 to 10, a flow from determination of a timing to detect erroneous connection or nonconnection of a facsimile line cable to displaying of an error message in a facsimile apparatus 1 according to Embodiment 2 of the present disclosure will be described.

Since a schematic configuration of the facsimile apparatus 1 according to Embodiment 2 of the present disclosure is the same as that of FIG. 1 (Embodiment 1), description thereof will be omitted.

FIG. 8 is a flowchart illustrating a flow from the determination of a timing to detect erroneous connection or nonconnection of a facsimile line cable to the displaying of an error message in the facsimile apparatus 1 according to Embodiment 2 of the present disclosure.

In step S21 of FIG. 8, a controller 8 of the facsimile apparatus 1 determines whether or not a timing to detect a line connection state has arrived (step S21).

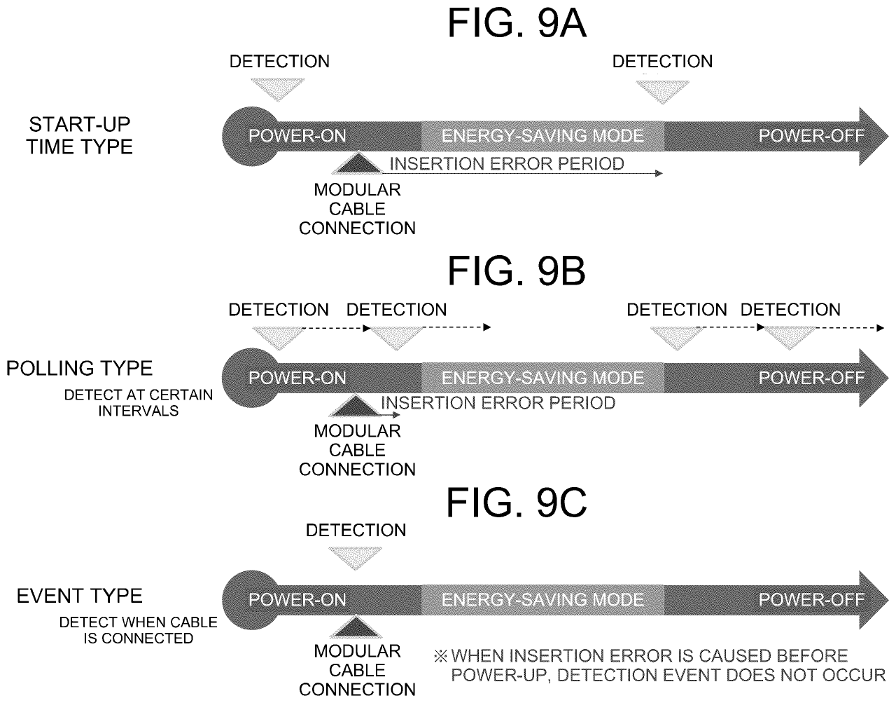

FIG. 9A, FIG. 9B, and FIG. 9C are explanatory diagrams illustrating examples of the timing to detect erroneous connection or nonconnection of the facsimile line cable of the facsimile apparatus 1 according to Embodiment 2 of the present disclosure.

Generally, it is considered that the timing at which the user makes a mistake in inserting a facsimile line cable is when the facsimile apparatus 1 is installed for the first time or the facsimile apparatus 1 is moved (when a layout change is made).

Thus, as such a timing, three types of timings, i.e., a start-up time type indicated in FIG. 9A, a polling type indicated in FIG. 9B, and an event type indicated in FIG. 9C, are considered. Each type of the timing will be described below.

As indicated in FIG. 9A, in the start-up time type, a connection state of the facsimile line cable is detected when the facsimile apparatus 1 is powered on and when the facsimile apparatus 1 is shifted from an energy-saving mode to a power-off.

An advantage of the start-up time type is that erroneous connection or nonconnection of the facsimile line cable can be detected immediately after a start-up of the facsimile apparatus 1, and an operation sound of the switching portion 16 can be mixed with a start-up sound of the facsimile apparatus 1 and be made less noticeable.

Meanwhile, a disadvantage of the start-up time type is that even if erroneous connection or nonconnection occurs in the facsimile line cable after a start-up of the facsimile apparatus 1, the occurrence cannot be detected immediately.

As indicated in FIG. 9B, in the polling type, after the facsimile apparatus 1 has been powered on, the connection state of the facsimile line cable is detected at intervals defined in advance.

An advantage of the polling type is that it is possible to periodically detect erroneous connection or nonconnection of the facsimile line cable after a start-up of the facsimile apparatus 1.

Meanwhile, a disadvantage of the polling type is that, in a case where an interval from one detection to the next detection is long, even if erroneous connection or nonconnection occurs in the facsimile line cable, the occurrence cannot be detected immediately.

Further, another disadvantage is that an operation sound of the switching portion 16 is periodically generated, and components of the switching portion 16 are easily worn out.

As indicated in FIG. 9C, in the event type, the connection state of the facsimile line cable is detected when the facsimile line cable is connected.

An advantage of the event type is that it is possible to detect erroneous connection or nonconnection of the facsimile line cable immediately after the facsimile line cable has been connected.

Meanwhile, a disadvantage of the event type is that when the facsimile apparatus 1 is powered off, even if erroneous connection or nonconnection occurs in the facsimile line cable, the occurrence cannot be detected.

Further, another disadvantage is that it is necessary to verify the operation of the modem 6 since the function of the modem 6 is used to know the time when the facsimile line cable is connected.

Note that the user may be enabled to set in advance which timing should be adopted among the three types of timings, i.e., the start-up time type indicated in FIG. 9A, the polling type indicated in FIG. 9B, and the event type indicated in FIG. 9C.

Next, in step S21 of FIG. 8, if the timing to detect the line connection state has not arrived yet (i.e., if it is determined as being No in step S21), the controller 8 returns the processing to the determination of step S21.

Meanwhile, if the timing to detect the line connection state has arrived (i.e., if it is determined as being Yes in step S21), in step S22, the controller 8 detects the line connection state (step S22).

Since a method of detecting the line connection state is the same as that of Embodiment 1 (FIG. 3), description thereof will be omitted.

Next, in step S23, the controller 8 determines whether or not erroneous connection or nonconnection of the facsimile line cable has been detected (step S23).

If no erroneous connection or nonconnection of the facsimile line cable is detected (i.e., if it is determined as being No in step S23), the controller 8 ends the processing.

Meanwhile, if erroneous connection or nonconnection of the facsimile line cable is detected (i.e., if it is determined as being Yes in step S23), in step S24, the controller 8 causes a display portion 11 to display an error message indicating erroneous connection or nonconnection of the facsimile line cable (step S24).

After that, the controller 8 ends the processing.

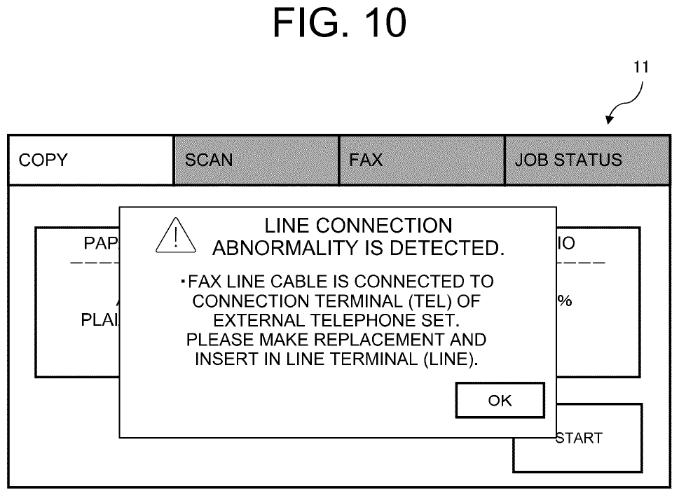

FIG. 10 is an example of an error message displayed on the display portion 11 when erroneous connection or nonconnection is detected for the facsimile line cable in the facsimile apparatus 1 according to Embodiment 2 of the present disclosure.

In the example of FIG. 10, an error message indicating “Line connection abnormality is detected. *Fax line cable is connected to connection terminal (TEL) of external telephone set. Please make replacement and insert in line terminal (LINE).” is displayed as a pop-up on the display portion 11.

When the user presses an “OK” button on the lower right part of the error message, the error message disappears.

In this way, it is possible to realize the facsimile apparatus 1 which is capable of detecting erroneous connection or nonconnection of the facsimile line cable at a more appropriate timing than by a conventional way and displaying an error message when the erroneous connection or nonconnection of the facsimile line cable is detected.

Preferred aspects of the present disclosure also include combinations of any of the aspects described above.

Various modifications may be made to the present disclosure in addition to the embodiments described above. Such modifications should not be construed as falling outside the scope of the present disclosure. The present disclosure should embrace the claims and their equivalents and all modifications within the scope of the claims.

What is claimed is:

1. A facsimile apparatus having a fax communication function of transmitting and receiving, to and from an external facsimile apparatus, facsimile image data via an exchange and a modem, and a telephone call function of switching to an external telephone and enabling a call to be made, the facsimile apparatus comprising:
a first terminal to which a facsimile line cable is to be connected;
a second terminal to which the external telephone is to be connected;
a line voltage detection sensor which is connected to the first terminal and detects a line voltage of the exchange;
a selector switch which makes a switch as to whether the second terminal is to be further connected to the line voltage detection sensor; and
at least one controller which controls the modem, the line voltage detection sensor, and the selector switch, wherein
the at least one controller controls the selector switch and determines, based on a first line voltage detected by the line voltage detection sensor when only the first terminal is connected to the line voltage detection sensor, and a second line voltage detected by the line voltage detection sensor when the first terminal and the second terminal are connected to the line voltage detection sensor, a connection state of the facsimile line cable.

2. The facsimile apparatus according to claim 1, further comprising a hook detection sensor which is connected to the second terminal and detects, based on a current which flows through a bidirectional photocoupler, whether an off-hook state is exhibited, wherein
when the connection state of the facsimile line cable is to be detected, if the second terminal is not connected to the line voltage detection sensor and the line voltage detection sensor does not detect a line voltage of the exchange, the at least one controller controls, when the off-hook state is detected by the hook detection sensor, the selector switch and connects the second terminal to the line voltage detection sensor, and when the line voltage detection sensor does not detect a line voltage of the exchange, the facsimile line cable is determined as being not connected, and when the line voltage detection sensor detects a line voltage of the exchange, the facsimile line cable is determined as being erroneously connected.

3. The facsimile apparatus according to claim 1, wherein when the connection state of the facsimile line cable is to be detected, if the second terminal is connected to the line voltage detection sensor and the line voltage detection sensor detects a line voltage of the exchange, the at least one controller controls the selector switch and disconnects the second terminal from the line voltage detection sensor, and when the line voltage detection sensor detects the line voltage of the exchange, the facsimile line cable is determined as being correctly connected, and when the line voltage detection sensor does not detect the line voltage of the exchange, the facsimile line cable is determined as being erroneously connected.

4. The facsimile apparatus according to claim 1, wherein the at least one controller detects the connection state of the facsimile line cable at one of a timing when a power source of the apparatus is turned on or off, a timing defined in advance, and a timing when a cable is connected to one of the first terminal and the second terminal.

5. The facsimile apparatus according to claim 1, further comprising a display which displays various kinds of information to a user, wherein
the at least one controller causes the display to display, when one of erroneous connection and nonconnection of the facsimile line cable is detected as a result of detection of the connection state of the facsimile line cable, an error message defined in advance.
